(19) United States
(12) Patent Application Publication
(10) Pub. No.: US 2006/0147592 A1
(43) Pub. Date: Jul. 6, 2006

(54) Method and arrangement related to a dough forming

(76) Inventor: Ivan Guentchev Kalaykov, OREBRO (SE)

Correspondence Address: DLA PIPER RUDNICK GRAY CARY US LLP;ATTN: PATENT GROUP, 1200 NINETEENTH STREET, NW, WASHINGTON, DC, 20036, US

(21) Appl. No.: 10/517,336

(22) PCT Filed: Jun. 10, 2003
(86) PCT No.: PCT/SE03/00953

§ 371 Date: Dec. 9, 2004

(30) Foreign Application Priority Data
Jun. 10, 2002 (SE) 0201782-0

(51) Int. Cl. A21D 6/00

(52) U.S. Cl. 426/504

(57) ABSTRACT

The present invention includes a first method, in order to be able to determine correlation function-related reference values, and a second method and an arrangement in order to allowing to determine, during a dough-forming phase or sequence of a dough structure having time-related increasing rheological properties in a dough mixer driven by an electric motor, a point of time (t3) when the rheological properties of the dough structure exhibit a preset value, by means of allowing to detect instantaneous current values of the supply current (4a′) connected to the motor (4) over time in a first means (51) during said dough-forming phase. In this connection, for said second method and said arrangement, it is suggested:
a. that a means (53) is adapted to allowing to evolve or calculate an envelope (53′) from the values (4a′) of the supply current detected in this way;
b. that a means (54) is adapted to time-adapted allowing to form a number of values (K1(t); K2(t)) based on a selected correlation function, by means of the evolved or calculated graph of said envelope;
c. that a means (55) is adapted to allowing to stop the dough-forming phase upon the achievement of a predetermined instantaneous value (eK1(t); eK2(t)) of the correlation function that joins or corresponds to a reference value (K1; K2) determined according to the first method or the like, and;
d. that the reference value (K1; K2) of the correlation function determined in this way is allowed to become related to the instantaneous rheological properties of the dough structure.

### TECHNICAL FIELD OF THE INVENTION

The present invention generally relates to methods and to an arrangement adapted to be related to a dough-forming sequence.

Recipe-related ingredients are placed in a dough mixer and mixed together by an agitator or the like, while the ingredients get co-ordinated and are developed so as to form a firmer and firmer dough structure.

In that connection, during the dough-forming sequence, the dough structure exhibits increasing rheological properties.

In particular, the present invention includes a first method, intended to allowing to determine, during a dough-forming phase or sequence of a recipe-adapted dough structure, having rheological properties increasing over time, in a dough mixer driven by an electric motor, in all events one value of a selected and employed correlation function, when the rheological properties of the dough structure exhibit a preset value, by means of allowing to detect current values of the supply current, connected to the motor, over time and in addition allowing to utilize means or electronic circuits in order to evolve or calculate an envelope from the values of the supply current detected in this way.

The invention also includes a second method, intended to allowing to determine a point of time, a selected point of time, during a dough-forming sequence and more particularly the point of time when the Theological properties of a dough structure exhibit a preset value and even more particularly to a method in order to allowing to determine, during a dough-forming phase or sequence of a dough structure having rheological properties increasing over time, in a dough mixer driven by an electric motor, the point of time when the rheological properties of the dough structure exhibit a preset value.

The second method according to the invention likewise relies on allowing to detect, over time, the varying current values that are supplied to the motor via the supply current during said phase of dough mixing and/or dough forming.

The invention further relies on allowing to utilize a means or electronic circuits in order to evolve or calculate an envelope from the values of the supply current detected in this way.

The present invention also discloses an arrangement, inter alia, adapted, in similarity with the second method above, to be capable of determining a point of time when the Theological properties of a dough structure exhibit a preset value.

### BACKGROUND OF THE INVENTION

Methods and arrangements of the character specified above are previously known in a plurality of different embodiments.

Every dough-mixing process or dough-forming sequence demands the evaluation of a selected point of time to stop the dough-forming operation or sequence, with the selected point of time in general being related to the current Theological properties exhibited by the dough structure formed.

In order to establish this point of time, when the dough-forming sequence is to be stopped, various methods that are based on different fundamental principles are available, viz.

1. Allowing statistical parameters, referring to varying current values that are supplied to the motor of the dough mixer via the supply current, during said dough-forming phase, to be taken into consideration and by doing so allowing to evaluate the mean value and the standard deviation of the variation of current. The patent publications WO 99/20113 and WO 00/02456 represent examples of this principle.

2. Allowing to carry out indefinite logical calculations, exploiting a number of formulae referring to qualitative variables, based on the elapsed time of mixing and the instantaneous power consumption supplied to the dough mixer, evaluated during the dough-forming sequence. Examples of this technique are shown and described in more detail in the patent publication U.S. Pat. No. 5,472,273.

3. Allowing to conduct expert-based evaluations, which then are based on the own insight of the expert, in order to allowing to evaluate the instantaneous status of the dough mixture.

It is previously known that these methods and arrangements exhibit certain advantages and certain disadvantages.

As an example hereupon, it could be mentioned that the first, above-mentioned, principle 1 may be implemented by means of unsophisticated measuring systems and standard data-processing, in order to, in this way, be able to obtain required information and the required statistical parameters emanating from detected signals.

However, this information has been proven to be easily and detrimentally affected by external sources of error, which are to be primarily related to the industrial environment.

Thus, any calculation of that kind will become impaired by different sources of error and where it is not infrequent that, due to particular circumstances, an incorrect point of time will be evaluated and established to stop the dough-forming operation.

The second principle 2, described above, employs more content of information and holds an intermediate position of the above-mentioned principles. In this application, the expert knowledge and insights are utilized, which are included in a selected micro check of the dough mixture and while taking the particular construction of the dough mixer into account.

However, the utilization of the expertise for this application becomes the subject of an increasing complexity, owing to that it does not make use of essential spectral properties that refer to the signal of the motor current and that may be seen as giving a measure of the changes of the rheological properties during the dough mixing and the dough-forming operation or sequence.

The third principle 3 is likely to be regarded as the least reliable and should at no event be solely utilized in automated production of dough structures and finished products, since the human factor becomes deeply involved and to transfer this insight to a software or as a hardware has turned out to be difficult.

Thus, as a first example of prior art and the technical field to which the present invention is related, under principle 1, may more particularly be mentioned the content of the international patent publication WO-A1-99/20113, corresponding to international patent application serial no. PCT/SE98/01889.

Here, a method and a baking plant are shown and described, where the object is to mix flour, water and other recipe-related ingredients in order to be able to produce a predetermined and/or foreseeable end or finished product, by means of a dough mixer and the evaluation of the increasing rheological properties of the dough structure.

In this connection, particularly it is disclosed to allowing to terminate the dough-forming phase at a point of time (“t3”, in FIG. 2) that occurs before the virtual point of time (“t1”), where the dough-forming phase would provide a dough structure exhibiting maximum Theological properties, if the dough-forming phase or sequence would be allowed to proceed and past said point of time (“t3”).

More particularly, it is disclosed to allowing to select said process so that the terminating point of time (“t3”) of dough forming becomes based on preset factors and where these factors at least should include the properties of the flour and/or various requirements on the finished product.

As a second example of prior art, and the technical field to which the invention is related, may be mentioned the content of the international patent publication WO-A1-00102456.

Here, a method is shown and described, related to a dough mixer, which measures other than the above-mentioned criteria in order to be able to determine the terminating point of time (t3), by means of utilising information related to the development over time of the Theological properties in the dough structure during the dough-forming sequence and by means of allowing to assume significant and well-defined points of times, designated (“ts” and “tc”, respectively), during the dough-forming sequence before the terminating point of time.

The content of the U.S. patent publication U.S. Pat. No. 5,472,273 belongs to the prior art, under the principle 2 above.

Here, a system is shown and described in order to be able to determine the development of the Theological properties of a dough structure during a dough-forming phase or sequence in a dough mixer.

Here, the possibility to allowing to detect, over time, current values of the supply current connected to the motor of the dough mixer is utilized.

More particularly, it is a question of allowing to utilize a monitor, which should follow a time-related power characteristic and be connected to a computer in order to be able to evaluate potential discrepancies and carry out corrections in relation to the criteria and conditions being stored in the memories of the computer.

More particularly, in FIG. 2A is shown the time graph of the power and in FIG. 2B the time graph of the standard deviation, and in doing so quantities that are related to mean value formations are utilized.

In the European patent application 90 301481.9, having the publication number EP-A1-0 428 241, a system is shown and described in order to, during the dough-forming phase of the dough structure where the supply of energy constitutes the ruling factor, allowing to terminate the dough forming at a selected energy value.

Also an article entitled “The Human Decision Making In the Dough-Mixing Process Estimated in an Artificial Sensor System”, by Peter Wide in “Journal of Food Engineering 39 (1999)” pages 39 to 46, belongs to prior art.

Considering the significant features associated with the present invention, it should be mentioned that it is, per se, known to allowing to provide, via mathematical calculations, values related to a “Correlation function”.

The establishment of such correlation functions is shown and described in more detail by I. Proakis, D. Manolakis, in a publication “Digital signal processing”, 3^{rd} edition, Prentice Hall, 1996.

As for the establishment of different values related to correlation functions, it may be mentioned that a so-called auto-correlation function and a so-called cross-correlation function are known, with the first-mentioned being utilized in the exemplifying embodiment described in the following.

### SUMMARY OF THE PRESENT INVENTION

### Technical Problem

Considering the circumstance that the technical considerations, which a person skilled in the art of the relevant technical field has to do in order to be able to present a solution of one or more posed technical problems, are, on one hand, initially a necessary understanding of the measures and/or the sequence of measures that have to be executed, and, on the other hand, a necessary choice of the means that is/are required, then, in this connection, the subsequent technical problems would be relevant at bringing forth the present subject matter of the invention.

When considering the prior art, such as it has been described above, it would be regarded as a technical problem to be capable of realising the significance of and the advantages associated with being able to provide such conditions, in a first method, that this method becomes adapted to allowing to determine, during a dough-forming phase of a recipe-adapted dough structure, having rheological properties increasing over time in a dough mixer driven by an electric motor, in all events one value, based on a selected and employed correlation function, when the Theological properties of the dough structure exhibit a preset value, by means of allowing to detect current values of the supply current connected to the motor over time and in addition allowing to utilize means or electronic circuits in order to evolve or calculate an envelope from the values of the supply current detected in this way.

In that connection, there is a technical problem to be capable of realising the significance of and the advantages associated with allowing to drive the dough forming in the dough mixer to a dough structure, selected by an operator or the like, and regarded as suitable for a subsequent processing to a finished product having predetermined properties.

In that connection, there is a technical problem to be capable of realising the significance of and the advantages associated with allowing to read and to evaluate one or more values, based on the selected correlation function.

There is a technical problem to be capable of realising the significance of and the advantages associated with allowing to stop the dough-forming phase and visually, etc., observe the rheological properties of the dough structure so that these exhibit a predetermined structure corresponding to a preset value.

In that connection, there is a technical problem to be capable of realising the significance of and the advantages associated with allowing the dough in the dough mixer to become the subject of a plant-related processing, for the forming of a selected finished product, that the product manufactured in this way is tested, with regard to predetermined requirements, and that upon compliance between a product manufactured in this way and requirements made, the values, according to “b”, are utilized as reference value.

In that connection, there is a technical problem to be capable of realising the significance of and the advantages associated with allowing the dough in the dough mixer to become the subject of a plant-related processing, for the forming of a finished product, that the product manufactured in this way is tested, with regard to predetermined requirements, and that upon a deficiency of compliance between manufactured product and requirements made the values are rectified or corrected, according to “b”, and a new recipe-adapted dough structure is driven to the values rectified in this way, the dough in the dough mixer becoming the subject of a plant-related processing, for the forming of a selected finished product, that the product manufactured once again in this way is tested, with regard to the predetermined requirements, and that upon a compliance between product and requirements, the values rectified or corrected in this way are utilized as reference values.

In addition, it would to be regarded as a technical problem that via a second method, by means of information on a “reference value” obtained from the first method, or by other means be able to provide such conditions that the point of time, when the rheological properties of a dough structure exhibit a preset value, should be evaluated in a more exact way than what is offered in connection with the above-mentioned prior art, in all events based on the principles mentioned under 1 and 2 above.

Then, there is a technical problem to be capable of realising the significance of and the advantages associated with, also here, allowing to evolve and utilize, in order to unambiguously be capable of determining a selected point of time, an envelope, based on a plurality of detected and processed values of the time-related alternating lapse of the supply current.

Moreover, there is a technical problem to be capable of realising the significance of and the advantages associated with, during the dough-forming sequence, allowing to determine a number of instantaneous values over time, each one of which being based on a calculation by means of a selected correlation function, by means of the relevant evolved or calculated graph of said envelope.

In addition, there is a technical problem to be capable of realising the significance of and the advantages associated with, at achievement of a preset value or reference value, for instance obtained from the first method of the correlation function, allowing to stop the dough-forming phase.

Moreover, there is a technical problem to be capable of realising the significance of and the advantages associated with allowing the determined value of the correlation function to be related to the rheological properties of the dough structure.

Besides, it would to be regarded as a technical problem to be capable of realising the significance of and the advantages associated with allowing said correlation function, as a first choice, to be selected as an auto-correlation function.

Besides, it would be regarded as a technical problem to be capable of realising the significance of and the advantages associated with allowing the number of values, based on applied correlation function, to be selected as two and co-ordinated.

Besides, it would to be regarded as a technical problem to be capable of realising the significance of and the advantages associated with allowing one of these values to be representative of a so-called measure of central value or tendency.

Besides, it would to be regarded as a technical problem to be capable of realising the significance of and the advantages associated with allowing said correlation function to be selected as a cross-correlation function.

It would to be regarded a technical problem to be capable of realising the significance of and the advantages associated with allowing one or more preset values or reference values of the correlation function to be selected, inter alia, in dependence of a subsequent plant-related processing, the structure of the plant and the like.

There is a technical problem to be capable of realising the significance of and the advantages associated with allowing the time-dependent values of the supply current to be evaluated by means of a time-shifted or time-displaced, signal-detecting, window, where the time duration of said window should be selectable from between 5 and 30 sec, such as between 10-15 sec.

Moreover, there is a technical problem to be capable of realising the significance of and the advantages associated with, in the above-mentioned application, providing such conditions that a time duration, selected within a detecting window, in part should be able to utilize the time-dependent values of the supply current

Furthermore, it would to be regarded as a technical problem to be capable of realising the significance of and the advantages associated with allowing an employed or used value of the correlation function, within a time-related first window, to be unambiguously adapted, such as lower, to corresponding values of a window being subsequent in time.

Moreover, there is a technical problem to be capable of realising the significance of and the advantages associated with, for the above-mentioned application, allowing to utilize a correlation function, which offers advantageous conditions in order to be able to suppress and/or eliminate occurring signal noise in the supply current connected to the motor and/or evolved or calculated envelope.

Moreover, there is a technical problem to be capable of realising the significance of and the advantages associated with allowing the preset value or reference value of the correlation function to be selected, inter alia, in dependence of a selected recipe, the construction of the dough mixer, the mixing and weight of selected ingredients and/or selected motor capacity.

There is a technical problem to be capable of realising the significance of and the advantages associated with allowing to evaluate the selected point of time by means of a particular and specified frequency analysis of the motor current.

Moreover, there is a technical problem to be capable of realising the significance of and the advantages associated with allowing to utilize a Fourier spectrum of a shifted or displaced detecting window for the motor current, with this spectral analysis being computer processed and time-related alterations being evaluated.

Moreover, there is a technical problem to be capable of realising the significance of and the advantages associated with allowing to detect the development of the dough forming by, during the dough-forming sequence, allowing to evaluate the instantaneous rheological properties that become related to the auto-correlation function's instantaneous values of the motor current within a shiftable or displaced detecting window.

### The Solution

In that connection, the present invention sets out from the known technique described by way of introduction and discloses two methods and one arrangement.

The first method is based on allowing to determine, during a dough-forming phase of a recipe-adapted dough structure, having Theological properties increasing over time in a dough mixer driven by an electric motor, in all events one value, a reference value, of a selected and employed correlation function, when the Theological properties of the dough structure exhibit a preset value, by means of allowing to detect current values of the supply current connected to the motor over time and in addition allowing to utilize means or electronic circuits in order to evolve or calculate an envelope from the values of the supply current detected in this way.

In order to be able to solve one or more of the above-mentioned technical problems, this method discloses the following sequence:
a. driving the dough forming in the dough mixer to a dough structure, selected by an operator or the like, and regarded and evaluated as suitable for a subsequent processing to a finished product, having predetermined properties;
b. reading one or more values, based on calculations by means of the selected correlation function, and;
c. simultaneously, or in all events substantially simultaneously, allowing to stop the dough-forming phase and, inter alia, visually observe the rheological properties of the dough structure so that these exhibit a predetermined structure corresponding to the preset value.

As proposed embodiments, coming or falling within the scope of the first method, it is disclosed that the dough in the dough mixer should become the subject of a plant-related processing, for the forming of a selected finished product, that the product manufactured in this way is tested, with regard to predetermined requirements, and that upon a compliance between product and requirements the values according to “b” are utilized as reference values.

Furthermore, it is disclosed that the dough in the dough mixer should become the subject of a plant-related processing, for the forming of a finished product, that the product manufactured in this way is tested, with regard to predetermined requirements, and that upon a deficiency of compliance between product and requirements the values are rectified or corrected, according to “b”, and a new recipe-adapted dough structure is driven to the values rectified in this way, the dough in the dough mixer becoming the subject of a plant-related processing, for the forming of a selected finished product, that the product manufactured in this way is tested, with regard to predetermined requirements, and that upon a compliance between product and requirements, the values rectified or corrected in this way are utilized as reference values.

The invention also includes a second method, based on one or more reference values, for instance obtained from the said first method, in order to allowing to determine, during a dough-forming phase of a dough structure, having time-related increasing rheological properties, in a dough mixer driven by an electric motor, a point of time when the rheological properties of the dough structure exhibit a preset value.

The method and arrangement are based on the known technique to allowing to detect current values of the supply current connected to the motor over time during said dough-forming phase in order to, during said dough-forming phase or sequence, allowing to evolve or calculate an envelope from the values of the supply current detected in this way.

In order to be able to solve one or more of the above-mentioned technical problems the present invention particularly discloses that the known technique should be supplemented by allowing to time-related form a number of values, based on a selected correlation function, by means of the evolved or calculated graph of said envelope.

Furthermore, it is disclosed that upon the achievement of a preset value (reference value) of the correlation function, conditions are provided to allowing to stop the dough-forming phase, the value of the correlation function determined in this way being set in relation to the rheological properties of the dough structure.

As proposed embodiments, coming within the scope of the fundamental idea of the present invention, it is disclosed that said correlation function should be selected as an auto-correlation function.

The number of instantaneous and co-ordinated values, based on selected correlation function, is selected to two, where one value should be representative of a measure of a central tendency or value.

Said correlation function may be selected as a cross-correlation function.

Furthermore, it is disclosed that the time-dependent values of the supply current should be evaluated by means of a time-shifted or time-displaced detecting window and where the time duration of said window may be selected from between 5 and 30 sec, such as between 10-15 sec.

Furthermore, it is disclosed that the preset value of the correlation function should be selected, inter alia, in dependence of a selected recipe, the construction of the dough mixer, the composition and weight of the selected ingredients and/or selected motor capacity.

Moreover, one or more preset values of the correlation function may be selected, inter alia, in dependence of a subsequent plant-related processing, the structure of the plant and the like.

### Advantages

The advantages that can be regarded as characteristic of the present invention and the particular significant features disclosed thereby, are that in this way conditions have been provided in order to readily be able to form reference values related to the correlation function and by means of these, in a more exact manner than previously, be able to evaluate a point of time when the Theological properties of a dough structure exhibit a preset value, by means of initially allowing to time-related evolve or calculation of an envelope of current values of the supply current connected to the motor detected over time and by means of this envelope provide a number of time-shifted or time-displaced instantaneous values, which are based on calculated values of a selected and employed correlation function, with the point of time being selected when one or more of these instantaneous values correspond to previously extracted reference values.

The invention relies on the fact that such a correlation function can present such an alteration over time of the calculated instantaneous values that they agree with the alteration over time of the rheological properties of the dough structure.

What is to be regarded as the significant characteristic of a first method, according to the present invention, is stated in the characterising clause of claim 1, what is to be regarded as the significant characteristic of a second method, according to the present invention, is stated in the characterising clause of claim 4, and what is to be regarded as the significant characteristic of an arrangement, according to the present invention, is stated in the characterising clause of claim 14.

### BRIEF DESCRIPTION OF THE DRAWINGS

Prior art and common knowledge in the prior art and a presently proposed embodiment, exhibiting the significant features associated with the present invention, will now, for the purpose of exemplifying, be closer described with reference to the appended drawings, where:

FIG. 1 schematically and partly in perspective view shows a dough mixer driven by an electric motor and having an appurtenant or related control circuit;

FIG. 2 in a graph shows how the Theological properties can be regarded to increase during a dough-forming phase or sequence of a dough structure and with an indicated point of time “t3”, where the dough-forming phase should be terminated;

FIG. 3 simplified shows an envelope evolved or calculated from a plurality of detected instantaneous values of the supply current at the start of a mixing of recipe-related ingredients, occurring in a solid state and/or of slurry consistency;

FIG. 4 simplified shows an envelope evolved or calculated from a plurality of detected instantaneous values at the end of a selected dough forming, with dough structure exhibiting the final rheological properties thereof;

FIG. 5 shows the general formula to calculate values based on an auto-correlation function;

FIG. 6 shows two values (K1(t); K2(t)) calculated by the auto-correlation function at the start of a mixing of recipe-related ingredients of a slurry consistency;

FIG. 7 shows two values calculated by the auto-correlation function upon termination of the dough forming, with the dough structure exhibiting the final rheological properties thereof;

FIG. 8 shows a three-dimensional representation of the time-dependent (t) and increasing alteration of the auto-correlation function, and;

FIG. 9 strongly simplified shows a control circuit brought together and interrelated according to the conditions of the invention, applicable in FIG. 1, for the electrically driven motor included in the dough mixer.

### DESCRIPTION OF PRESENTLY PROPOSED EMBODIMENT

Then, by way of introduction, it should be emphasised that in the subsequent description of a presently proposed embodiment, exhibiting the significant features associated with the invention and being elucidated by the figures illustrated in the subsequent drawings, we have chosen terms and a particular terminology with the purpose of, in that connection, first of all allowing to make evident the inventive idea.

However, in this context it should be taken into consideration that expressions selected here should not be regarded as limiting only to terms utilized and selected here but it should be implied that any term selected in this way should be interpreted such that it in addition covers all technical equivalents that work in the same or substantially the same way in order to, in that connection, be able to attain the same or substantially the same intention and/or technical effect.

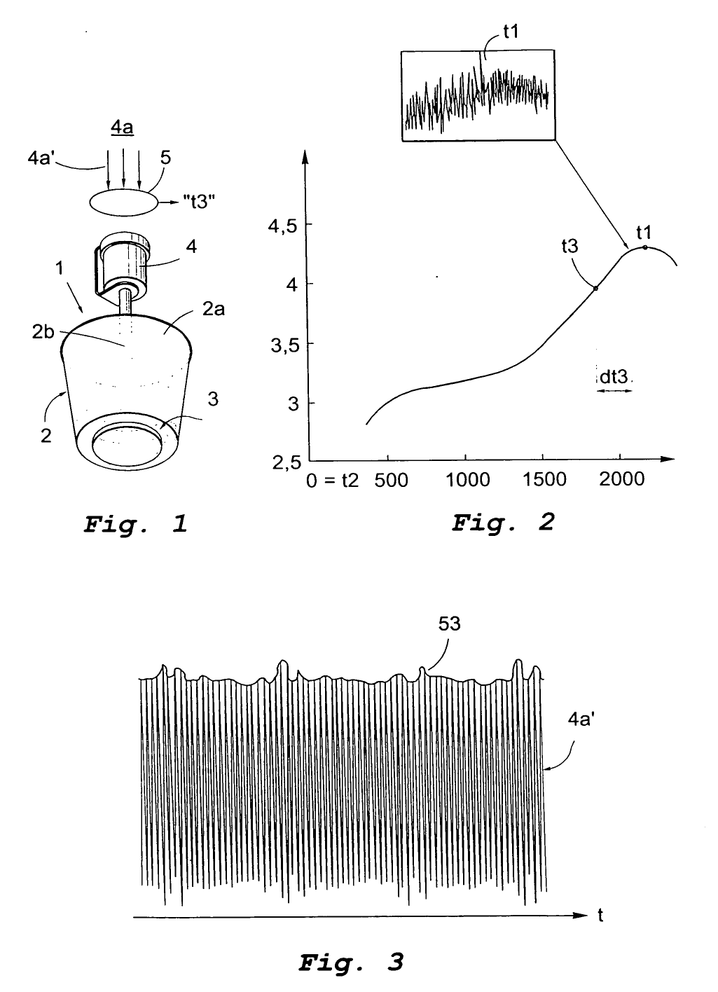

Reference is made to FIG. 1, where the fundamental conditions of prior art and of the present invention schematically are shown, with the significant peculiarities associated with the invention generally having been concretised, by an embodiment presently proposed and subsequently closer described.

Thus, FIG. 1 shows an arrangement 1, according to prior art and supplemented by functions related to the present invention, which arrangement 1 furthermore is adapted to be able to carry out each of the methods in accordance with the invention.

The arrangement 1 consists of a dough mixer 2, having a dough pan 2a and a dough hook 2b as well as an enclosed dough structure 3, the Theological properties of which are being altered during the dough forming, such as from a recipe-related slurry consistency to a more solid consistency.

For the application thereof, the present invention does not require any particular shape of the dough pan 2a or any particular shape of the dough hook 2b, and hence nothing prevents to allow the dough pan 2a to be rotatable in a first direction while the dough hook 2b may be rotatable in an opposite direction.

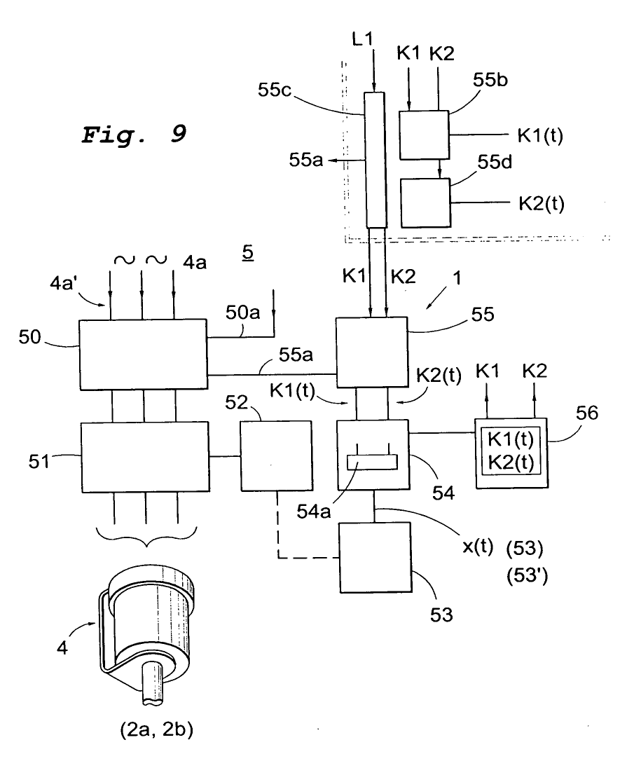

The arrangement, according to FIG. 1, also shows the utilization of an electrically driven three-phase motor 4, which via a three-phase network 4a, having alternating current values 4a′ varying over time, interacts with a control circuit 5, which control circuit is closer described in connection with FIG. 9, for an application in accordance with the directions of the invention.

More particular the embodiment discloses, according to FIG. 1, an arrangement 1 in order to allowing to determine, during a dough-forming phase or sequence of a dough structure 3, having time-related increasing rheological properties between the point of times “t2” and “t1”, according to FIG. 2, in a dough mixer 2 driven by an electric motor 4, a point of time “t3”, when the rheological properties of the dough structure exhibit a preset value, occurring somewhat before a point of time “t1”, where the rheological properties of the dough structure 3 exhibit a maximised value.

The invention relies on, inter alia, to provide such conditions in the control unit 5 to allowing to detect therein instantaneous current values 4a′ of the supply current connected to the motor 4 over time during said dough-forming phase.

In order to be able to determine the point of time “t3”, the invention requires one or more reference values.

Determining these reference values may advantageously be effected in the arrangement 1, according to FIG. 1, by means of a first method.

In that connection, this first method is adapted to allowing to determine, during a dough-forming phase of a recipe-adapted dough structure, having rheological properties increasing over time in a dough mixer 2 driven by an electric motor 4, in all events one value of a selected and employed correlation function, when the rheological properties of the dough structure exhibit a preset value, by means of allowing to detect current values of the supply current connected to the motor over time and in addition allowing to utilize known means in order to evolve and calculate an envelope from the values of the supply current detected in this way.

This method relies on the sequence:

a. Driving the dough forming in the dough mixer to a dough structure, selected by an operator or the like, and regarded as suitable for a subsequent processing to a finished and desired product of bread having predetermined properties;
b. At this point of time reading one or more values, constituting or assumed as reference values based on or calculated via the selected correlation function, and;
c. Simultaneously, or in all events substantially simultaneously, allowing to stop the dough-forming phase or sequence and observe the Theological properties of the dough structure so that these exhibit selected dough structure and thereby the preset value.

It is particularly disclosed that the dough in the dough mixer should become the subject of a plant-related processing, for the forming of a selected finished product (baked product of bread), that the product manufactured in this way is tested, with regard to predetermined requirements, and that upon compliance between product manufactured in this way and assumed and requirements made, the values read, according to “b”, are utilized as reference values (K1; K2).

As an alternative, it is disclosed that the dough in the dough mixer should become the subject of a plant-related processing, for the forming of a finished product, that the product manufactured in this way is tested, with regard to predetermined requirements, and that upon a deficiency of compliance between product and requirements the values are rectified or corrected read, according to “b”, and a new recipe-adapted dough structure is driven to the values rectified and corrected in this way, the dough in the dough mixer becoming the subject of a plant-related processing, for the forming of a selected finished product, that the product manufactured in this way is tested, with regard to predetermined requirements, and that upon compliance between product and requirements, the values rectified in this way are utilized as reference values for a subsequent second method.

The second method relies on allowing to determine, by means of one or more reference values, preferably obtained from the first method, during a dough-forming phase of a dough structure 3 having time-related increasing rheological properties in a dough mixer driven by an electric motor 2, a point of time “t3” when the rheological properties of the dough structure exhibit a preset value, by means of allowing to detect current values of the supply current 4a′ connected to the motor 4 over time during said dough-forming phase or sequence, and in addition allowing to utilize means or circuits in order to evolve or calculate an envelope 53, 53′ from the values of the supply current 4a′ detected in this way.

This second method discloses:

a. to time-related allowing to form a number of values (K1(t); K2(t)), based on a selected correlation function, by means of the evolved or calculated graph of said envelope;
b. to allowing to stop the dough-forming phase upon the achievement of a preset value, such as said reference value (K1; K2) of the correlation function, and;
c. that the value of the correlation function determined in this way is set in relation to the rheological properties of the dough structure.

The time-dependent values of the supply current 4a′ should be evaluated by means of a time-shifted or time-displaced current-detecting window, with the time duration within said window being selected from between 5 and 30 sec, such as between 10-15 sec.

Values of the correlation function, within a time-related first window, are selected lower than corresponding values in a window being subsequent in time, which is shown with clarity in FIG. 8.

One or more preset values of the correlation function are selected, inter alia, in dependence of a selected recipe, the construction of the dough mixer, the mixing and weight of selected ingredients and/or selected motor capacity.

More particularly it is disclosed that said correlation function should be selected as an auto-correlation function, the number of values, based on the selected auto-correlation function, being selected to two, where one value should be representative of a measure of central tendency or value.

As an alternative, said correlation function may be selected as a cross-correlation function.

One or more preset values of the correlation function are selected, inter alia, in dependence of a subsequent plant-related processing, the structure of the plant and the like.

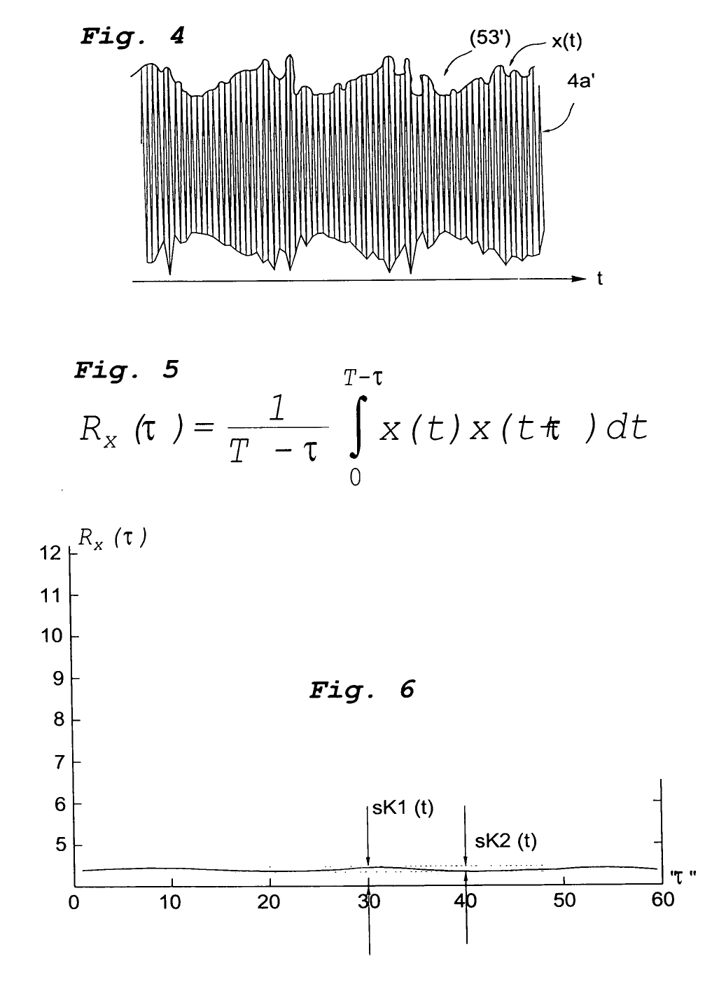

In FIG. 3 an envelope (53) is shown simplified, evolved or calculated from a plurality of detected values of the supply current 4a′ at the start of a dough mixing of recipe-related ingredients of slurry consistency.

In FIG. 4 an envelope (53) is shown simplified, evolved or calculated from a plurality of detected values upon termination of the dough forming, here with the dough structure exhibiting the final Theological properties thereof.

The graph according to FIG. 4 can be regarded as representative of the variation in connection to the point of time “t3” in FIG. 2.

In FIG. 4, it is particularly seen that the envelope (53′) at this stage exhibit, in relation to the supply frequency of the current to the motor 4, a sub-frequency that can be referred to the rate of rotation of the dough hook 2b.

It is, in this connection, evident that the time duration of the time-shifted or time-displaced current-detecting window is considerably longer than that indicated in FIGS. 3 and 4.

Referring to FIG. 5, there is shown the generic form in order to evolve or calculate instantaneous values based on the auto-correlation function and which correlation function has been proven to be of particular importance for the precision of the present invention, in order to, in this way, being able to evaluate and determine the point of time “t3” when to terminate the sequence of dough mixing.

Previously known are a number of circuit designs that are able to process and calculate envelope-related current values, in accordance with the formula according to FIG. 5, for what reason these circuit designs are not shown in more detail.

In particular, the embodiment will utilize circuit designs that from a single input signal x(t) will be capable of generating two specific values, designated K1(t) and K2(t).

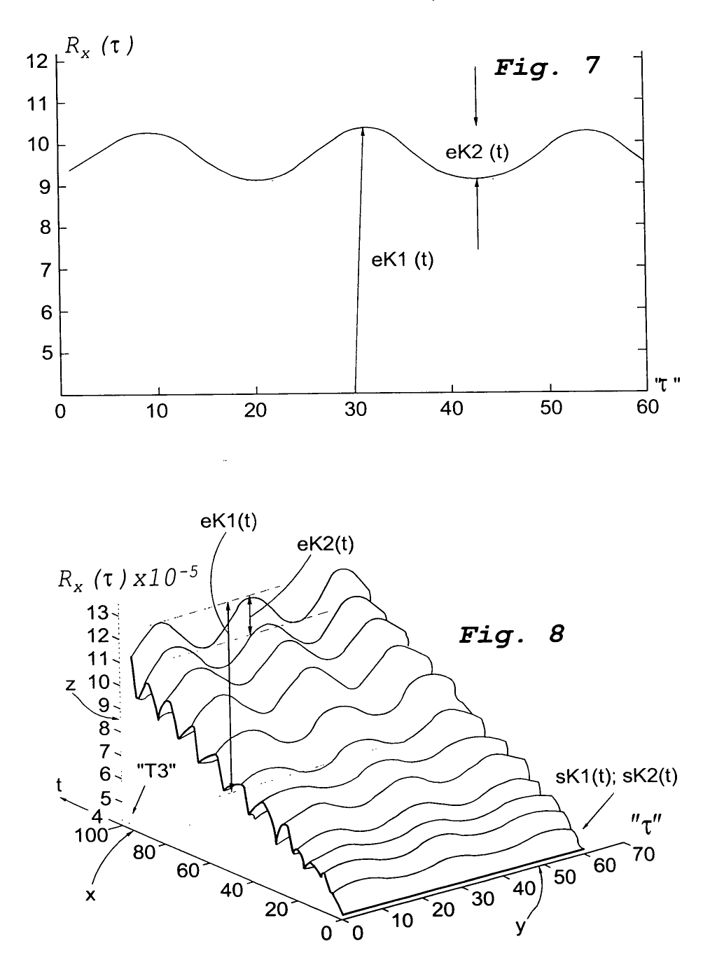

FIG. 6 is intended to show two of the values of the correlation function designated sK1(t) and sK2(t), occurring at the start of a mixing of recipe-related ingredients of slurry consistency, while FIG. 7 is intended to show two of the values of the correlation function designated eK1(t) and eK2(t), at the end of dough forming, with the dough structure exhibiting the final rheological properties thereof at the point of time “t3” and where the dough-forming sequence should be terminated and the dough structure be removed from the dough mixer 2.

During the entire process or sequence of mixing recipe-related ingredients to a dough, the sequence develops from a simple mechanical admixture of flour, water and other ingredients of slurry consistency, at the beginning of the dough-forming operation, to a continuous elastic compound, having increasing and desired rheological properties.

The motor 4, which drives the dough mixer 2 and the dough hook 2b, has to deliver a torque that overcomes the resistance presented by the dough 3 in the dough pan 2a.

Initially, this compound (slurry) has, accordingly, a very small resistance, since the admixture has not yet been transformed to a continuous compound.

Thus, the motor current 4a′ is relatively small and having substantially permanent parameters, as is seen in FIG. 3.

This also corresponds to an initial period of a low speed of the dough hook 2b in relation to the dough pan 2a, in order to keep recipe-related ingredients from splashing out of the dough pan 2a

During the time when the dough 3 is developing more and more to a continuous compound having increasing elasticity, also the resistance is increasing, thereby requiring a higher torque of the motor 4 at the same number of revolutions.

This results in an increasing motor current 4a′, and it has turned out that the parameters of this are changed in such a way that the amplitude is changed when the dough assumes different form and elasticity within the dough pan 2a, with the variation over time of the motor current at the final part of the mixing, in connection with “t3”, being schematically put forward in FIG. 4.

By determining the character of the motor current 4a′ in this way, it comes within the possibilities of the invention to more exactly allowing to determine and calculate the characteristic of the signal of the motor current.

Here, the present invention discloses the utilization of a mathematical calculation, according to the formula shown in FIG. 5, in order to obtain two different values of an auto-correlation function of the signal, according to the equation shown in FIG. 5, where “x (t)” constitutes the signal being analysed, “T” is the time window of the observation, and “τ” is the argument of the correlation function. Rₓ(τ) is the well known symmetrical function within statistical signal analysis.

As the dough structure exhibits increasing Theological properties, the motor current 4a′ is being altered increasingly and it is evident that the two selected values K1(t) and K2(t) of the auto-correlation function also are being altered increasingly in dependence of the time.

In connection with the measures disclosed here, then it becomes apparent that the following values will be altered:

a) the measure of central tendency or value (the zero argument);

b) the first minimal value (symmetric to the value of the zero argument), and;

c) the mean value.

For this, these values may be used as characteristic values of the different phases during the dough-forming operation.

In order to illustrate this, being valid for the entire development of the dough forming and values K1(t) and K2(t) of the auto-correlation function related thereto, in FIG. 8 a three-dimensional representation of the time-related and increasing alteration of the correlation function is shown.

The three-dimensional representation, according to FIG. 8, shows along the “-x”-axis (0-100) a time axis (t), along the “y”-axis (0-70) the argument of the correlation function (τ), and along the “z”-axis (4-13×10⁻⁵) the alteration over time of the auto-correlation.

With reference to FIG. 9, there is illustrated a three-phase motor 4, connected to the control circuit 5, with the control circuit 5 comprising a three-phase contactor 50, whereby a signal in a cable 50a can start the motor 4 for the dough-forming phase, illustrated in FIG. 2.

The reference designation 51 represents a first means, which is adapted to allowing to detect the time-dependent variation of the supply current 4a′, at a very small power extraction at the on-set of the dough-forming phase or sequence and at an increasing power extraction as the dough structure 3 exhibits increasing rheological properties.

The reference designation or numeral 52 represents a second means or an interface, wherein the variation over time of the supply current 4a′ is transformed or is adapted.

The reference designation 53 represents a third means, wherein conditions are provided in order to, from the variation over time of the supply current 4a′ and from signals from the interface 52, allowing to evolve or calculate an envelope from the values of the supply current detected in this way and the variation over time thereof.

An envelope (53) is shown in FIG. 3 and an altered envelope (53′) is shown in FIG. 4.

FIG. 9 also illustrates a fourth means 54, which comprises a so-called correlometer 54a, which is adapted to, from values “x(t)” of a signal, allowing to form corresponding values K1(t) and K2(t), respectively, with these at the on-set of the dough-forming sequence having been designated sK1(t) and sK2(t), respectively, and at point of time “t3” having been designated eK1(t) and eK2(t), respectively.

Thus, the fourth means 54 becomes adapted to allowing to determine a number of values within different time periods and consecutively over time, which values are representative of a calculation according to the correlation function, based on the current curve shape of said envelope, with FIG. 8 showing the variation over time of the two values of the correlation function in a three-dimensional representation.

To the fourth means 54 a sixth means 56 is connected, in the form of a display unit, where the calculated, varying and time-related increasing values K1(t) and K2(t) are displayed and are stored by means of the first method.

Furthermore, the invention discloses the utilization of a fifth means 55, which is adapted to, upon the achievement of a preset desired value supplied to the means 55, which value is designated “K1” or “K2” of the correlation function, allowing to stop the dough-forming phase, by means of cutting the power supply to the motor 4 in a cable 55a to the contactor 50.

Thus, the block 52 constitutes an interface to supply signals representative of the instantaneous current values to the control unit 5. In the block 53, the envelope of the motor current is obtained and in the block 54 signals, representative of the auto-correlation function of each shifted or displaced window or time period, are computer processed.

Accordingly, here two essential parameters or values K1(t) and K2(t) are frequently evaluated via the auto-correlation function, viz. maximum (the central point of the auto-correlation function), here designated K1(t), and the difference between maximum and the first minimum, designated K2(t). In this application, these two parameters K1(t) and K2(t) vary increasingly over time.

When these parameters or values are large enough at the point of time “t3”, the best rheological properties of the dough 3 are attained, in dependence of previously stated conditions.

Thus, the present invention discloses the utilization of two limit values valid as reference values, designated K1 and K2, and which are to be supplied to a comparative fifth means or block 55, which compare each instantaneously calculated value of K1(t) with the reference value K1 and each instantaneously calculated value K2(t) with the reference value K2.

When the value K1(t) becomes larger than K1 and the value K2(t) becomes larger than K2, the fifth means, in the form of a comparator 55, generates a control signal 55a to the contactor 50, in order to disengage the motor 4.

In FIG. 9, the principle of the fifth means 55 is shown cut-in in more detail, with the reference value K1 and instantaneous values K1(t) being supplied into a first comparator circuit 55b, which submit signal to an AND-gate 55c as soon as the value of K1(t) equals or exceeds the reference value K1.

The reference value K2 and the instantaneous value K2(t) are supplied into a second comparator circuit 55d, that submit signal to the AND-gate 55c as soon as the value of K2(t) equals or exceeds the reference value K2.

The AND-gate 55c submit signal in the cable 55a as soon as both of the value K1(t) and the value K2(t) exceed the respective reference values K1 and K2 thereof, and this is represented by the point of time “t3”. Thus, the point of time “t3” is variable in dependence of selected reference values K1 and K2, respectively.

Accordingly, in the first method the reference values K1 and K2, respectively, can be determined via a look upon the display unit 56 and these values may be supplied into the fifth means 55 in the second method.

FIG. 9 also discloses the utilization of a control signal in a cable L1 for the AND-gate 55c, in order to, in this way, be able to select operating condition.

Thus, a logical “0” in the cable L1 gives conditions to evaluate the reference value, in the first method, and a logical “1” gives conditions for operation by means of a selected reference value, in the second method.

Furthermore, it is disclosed that the preset value of the correlation function, say the reference value “K1” and “K2” are selected, inter alia, in dependence of a selected recipe, the construction of the dough mixer, the mixing of selected ingredients, weight and/or selected motor capacity and/or subsequent processing.

Accordingly, the reference values and the current point of time “t3”, when the dough-forming phase is to be stopped, become dependent on a plurality of different factors and the matter is to make a co-ordination of the factors that are related to selected ingredients, the factors that are related to the finished product and the factors that are related to the baking process and to the individual units of the baking process.

Thus, the reference values “K1” and/or “K2” will be selected in dependence of utilized ingredients:
a. the total composition of the ingredients placed in the dough mixer;
b. the properties of the flour and the mixture of the flour, in accordance with one or more data obtained by the Farinograph Method;
c. the time-dependent modification of the flour and other ingredients, and;
d. the Theological and/or the viscoelastic properties of the flour and other ingredients.

Factors that have been related to the finished product and that require an adaptation of the reference value “K1” and/or “K2” are:
a. the character and the structure of the finished product, (bread, loaf, cookies and the like);
b. the porosity of the finished product;
c. the volumetric measure of the finished product (length, width, height), and;
d. the durability or the freshness of the finished product.

Factors that have been related to the baking equipment and that require an adaptation of the reference value “K1” and/or “K2” are:
a. the construction of the dough mixer;
b. the mixing capacity of the dough mixer and the selection of velocity;
c. rapid or slow dough-mixing unit;
d. the construction of a weighing machine;
e. the construction for the duration of the loaf kneading and forming member or section of the equipment;
f. the duration of the rest time of the dough or the time of fermentation;
g. the length of the shelf life, the temperature and the construction of the storage space:
h. the construction of the oven, selection of temperature, selection of temperature alterations and the time in the oven, and;
i. the construction of the cooling zone, selection of temperature, selection of temperature alterations and the time in a cooling zone.

Thus, when the desired value or the reference value “K1” and/or “K2” is/are established, the dough structure 3 may be allowed to develop over time to the point of time “t3”, where an instantaneous value “eK1(t)” joins or corresponds to the desired value “K1” and an instantaneous value “K2(t)” joins the desired value “eK2”, where the means 55 is activated in order to terminate the dough mixing via signal in the cable 55a.

Of course, the invention is not limited to the above indicated embodiment given as an example, but may undergo modifications within the scope of the inventive idea illustrated in subsequent claims.

Special notice should be paid that, within the scope, every single unit shown may be combined with any other unit shown in order to be able to attain desired technical function.

1. Method in order to allowing to establish, during a dough-forming phase of a recipe-adapted dough structure, having rheological properties increasing over time in a dough mixer driven by an electric motor, in all events one value of a selected and employed correlation function, when the rheological properties of the dough structure exhibit a preset value, by means of allowing to detect current values of the supply current connected to the motor over time and in addition allowing to utilize means in order to evolve or calculate an envelope from the values of the supply current detected in this way, characterized in that, to allowing:
a. to drive or proceed with the dough forming in the dough mixer to a dough structure, selected by an operator or the like, and regarded as suitable for a subsequent processing to a finished product having predetermined properties;
b. to read one or more values, based on a calculation via the selected correlation function, and;
c. simultaneously, or in all events substantially simultaneously, to stop the dough-forming phase and observe the rheological properties of the dough structure so that these exhibit the preset value.

2. Method according to claim 1, characterized in that the dough in the dough mixer becomes the subject of a plant-related processing, for the forming of a selected finished product, that the product manufactured in this way is tested, with regard to predetermined requirements, and that upon compliance between product and requirements the values, according to “b”, are utilized as reference value.

3. Method according to claim 1, characterized in that the dough in the dough mixer should become the subject of a plant-related processing, for the forming of a finished product, that the product manufactured in this way is tested, with regard to predetermined requirements, and that upon a deficiency or discrepancy of compliance between product and requirements the values are rectified or corrected, according to “b”, and a new recipe-adapted dough structure is driven to the values rectified and corrected in this way, the dough in the dough mixer becoming the subject of a plant-related processing, for the forming of a selected finished product, that the product manufactured in this way is tested, with regard to predetermined requirements, and that upon a compliance between product and requirements, the values rectified and corrected in this way are utilized as reference values.

4. Method in order to allowing to establish, during a dough-forming phase of a dough structure (3) having time-related increasing rheological properties in a dough mixer (2) driven by an electric motor, a point of time (t3) when the rheological properties of the dough structure exhibit a preset value, by means of allowing to detect current values of the supply current (4a) connected to the motor (4) over time during said dough-forming phase, and in addition allowing to utilize means in order to evolve or calculate an envelope (53,53′) from the values of the supply current (4a′) detected in this way, characterized in that:
a. to time-related allowing to form a number of values (K1(t); K2(t)), based on a calculation via a selected correlation function, by means of the evolved or calculated graph of said envelope;
b. to allowing to stop the dough-forming phase upon the achievement of a preset value (the reference value) of the correlation function (K1, K2), and;
c. the value of the correlation function, determined in this way, is set in relation to the Theological properties of the dough structure.

5. Method according to claim 4, characterized in that said correlation function is selected as an auto-correlation function.

6. Method according to claim 4, characterized in that the number of values, based on selected correlation function, are selected to two.

7. Method according to claim 6, characterized in that one value should be representative of a measure of central tendency or value.

8. Method according to claim 4, characterized in that said correlation function is selected as a cross-correlation function.

9. Method according to claim 4, characterized in that the time-dependent values of the supply current (4a′) are evaluated by means of a time-shifted or phase-displaced current-detecting window.

10. Method according to claim 9, characterized in that the time duration within said window is selected from between 5 and 30 sec, such as between 10-15 sec.

11. Method according to claim 4, characterized in that the values of the correlation function, within a time-related first window, are selected lower than the corresponding values in a window being subsequent in time.

12. Method according to claim 4, characterized in that one or more preset values of the correlation function are selected, inter alia, in dependence of a selected recipe, the construction of the dough mixer, the mixing and weight of selected ingredients and/or selected motor capacity.

13. Method according to claim 4, characterized in that one or more preset values of the correlation function are selected, inter alia, in dependence of a subsequent plant-related processing, the structure of the plant and the like.

14. Arrangement in order to allowing to determine, during a dough-forming phase of a dough structure (3) having time-related increasing Theological properties in a dough mixer (2) driven by an electric motor (4), a point of time (t3) when the Theological properties of the dough structure exhibit a preset value, by means of allowing to detect current values (4a′) of the supply current connected to the motor (4) over time during said dough-forming phase and in addition allowing to utilize a means (53), which is adapted to allowing to evolve or calculate an envelope from the values of the supply current (4a′) detected in this way, characterized in that:
a. a means (54) is adapted to time-related allowing to determine a number of values, based on a selected correlation function, by means of the evolved or calculated graph of said envelope;
b. a means (55) is adapted to allowing to stop the dough-forming phase upon the achievement of a preset value (reference value) of the correlation function, and;
c. the value of the correlation function determined in this way, according to “b”, is allowed to become related to the rheological properties of the dough structure.

15. Arrangement according to claim 14, characterized in that said correlation function is constituted of an auto-correlation function.

16. Arrangement according to claim 14, characterized in that the number of values, based on and obtained from the selected correlation function, are selected to two.

17. Arrangement according to claim 16, characterized in that one of these two values should be representative of a measure of central tendency or value.

18. Arrangement according to claim 14, characterized in that said correlation function is selected as a cross-correlation function.

19. Arrangement according to claim 14, characterized in that the time-dependent values of the supply current are evaluated via a means by means of a time-shifted or time displaced current-detecting window.

20. Arrangement according to claim 19, characterized in that the time duration within said window is selected from between 5 and 30 sec, such as between 10-15 sec.

21. Arrangement according to claim 14, characterized in that the values of the correlation function, within a time-related first window, are adapted to be lower than corresponding values of a window being subsequent in time.

22. Arrangement according to claim 14, characterized in that one or more preset values of the correlation function are selected, inter alia, in dependence of a selected recipe, the construction of the dough mixer, the mixing and weight of selected ingredients and/or selected motor capacity.

23. Arrangement according to claim 14, characterized in that one or more preset values of the correlation function are selected, inter alia, in dependence of a subsequent plant-related processing, the structure of the plant and the like.
